(19) United States
(12) Patent Application Publication
(10) Pub. No.: US 2014/0006440 A1
(43) Pub. Date: Jan. 2, 2014

(54) METHOD AND APPARATUS FOR SEARCHING FOR SOFTWARE APPLICATIONS

(71) Applicants: Andrea G. Forte, Brooklyn, NY (US); Baris Coskun, Weehawken, NJ (US); Qi Shen, New York, NY (US); Ilona Murynets, Rutherford, NJ (US); Jeffrey Bickford, Somerset, NJ (US); Mikhail Istomin, Brooklyn, NY (US); Paul Giura, Cairo, NY (US); Roger Piqueras Jover, New York, NY (US); Ramesh Subbaraman, Jersey City, NJ (US); Suhas Mathur, Bayonne, NJ (US); Wei Wang, Hoboken, NJ (US)

(72) Inventors: Andrea G. Forte, Brooklyn, NY (US); Baris Coskun, Weehawken, NJ (US); Qi Shen, New York, NY (US); Ilona Murynets, Rutherford, NJ (US); Jeffrey Bickford, Somerset, NJ (US); Mikhail Istomin, Brooklyn, NY (US); Paul Giura, Cairo, NY (US); Roger Piqueras Jover, New York, NY (US); Ramesh Subbaraman, Jersey City, NJ (US); Suhas Mathur, Bayonne, NJ (US); Wei Wang, Hoboken, NJ (US)

(21) Appl. No.: 13/540,286

(22) Filed: Jul. 2, 2012

(51) Int. Cl. G06F 17/30

(52) U.S. Cl. 707/769; 707/E17.014

(57) ABSTRACT

A method, non-transitory computer readable medium and apparatus for searching for an application are disclosed. For example, the method receives information regarding a context of a user, receives a search request for the application, finds the application that has context information that matches the context of the user, and provides a search result in response to the search request that includes the application that has the context information that matches the context of the user.

The present disclosure relates generally to software applications and, more particularly, to a method and apparatus for searching for applications and faster retrieval.

### BACKGROUND

Mobile endpoint device use has increased in popularity in the past few years. Associated with the mobile endpoint devices are the proliferation of software applications (broadly known as “apps” or “applications”) that are created for the mobile endpoint device.

The number of available apps is growing at an alarming rate. Currently, hundreds of thousands of apps are available to users via app stores such as Apple's® app store and Google's® Android marketplace or Google Play. With such a large number of available apps, it would be very time consuming for users to manually search for an app that is of interest to them.

Currently, a user can only search for an app in a rudimentary fashion, e.g., based predominately on matching key words. As a result, some apps may not be returned in the search result if they do not exactly match the key words used for the search. In addition, the apps found in response to the search may not be applicable for the user's current situation.

### SUMMARY

In one embodiment, the present disclosure provides a method for searching for an application. For example, the method receives information regarding a context of a user, receives a search request for the application, finds the application that has context information that matches the context of the user, and provides a search result in response to the search request that includes the application that has the context information that matches the context of the user.

### BRIEF DESCRIPTION OF THE DRAWINGS

The present disclosure can be readily understood by considering the following detailed description in conjunction with the accompanying drawings, in which:

FIG. 1 illustrates one example of a communications network of the present disclosure;

FIG. 2 illustrates an example functional framework flow diagram for app searching;

FIG. 3 illustrates an example flowchart of one embodiment of a method for searching for and retrieving an app; and

FIG. 4 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present disclosure broadly discloses a method, non-transitory computer readable medium and apparatus for searching for and retrieving software applications (“apps”). The growing popularity of apps for mobile endpoint devices has lead to an explosion of the number of apps that are available. Currently, a user can only search for an app in a rudimentary fashion, for example using only a key word search.

However, a key word search may not necessarily present apps to users that they can use in their current circumstances. For example, a user may be cooking and looking for an app that will provide some entertainment while he or she is cooking. As a result, if a user searches for apps under “entertainment”, the simple key word search may result in apps such as video games that the user would be unable to use since the user's hands are being used for cooking, as opposed to a radio app that would allow the user to use his or her available senses such as the user's ears to listen without using the user's hands.

In addition, the key word search may only return search results that include at least one instance of an exact match of the key word. Thus, if an app does not include the key word in its title, it may not be included in the search result. For example, the key word search may be entered for a “flying” app. However, apps such as a “flight simulator” may not be included in the search results because there is no exact match with respect to the search term “flying”.

In one embodiment, the present disclosure resolves the above issues by providing a context search and a topic model search. The context search and the topic model search may provide a broader result of apps. More advantageously, the apps that are identified will be more appropriate with respect to a context associated with a user, e.g., what senses are available to a user or what activities the user is performing.

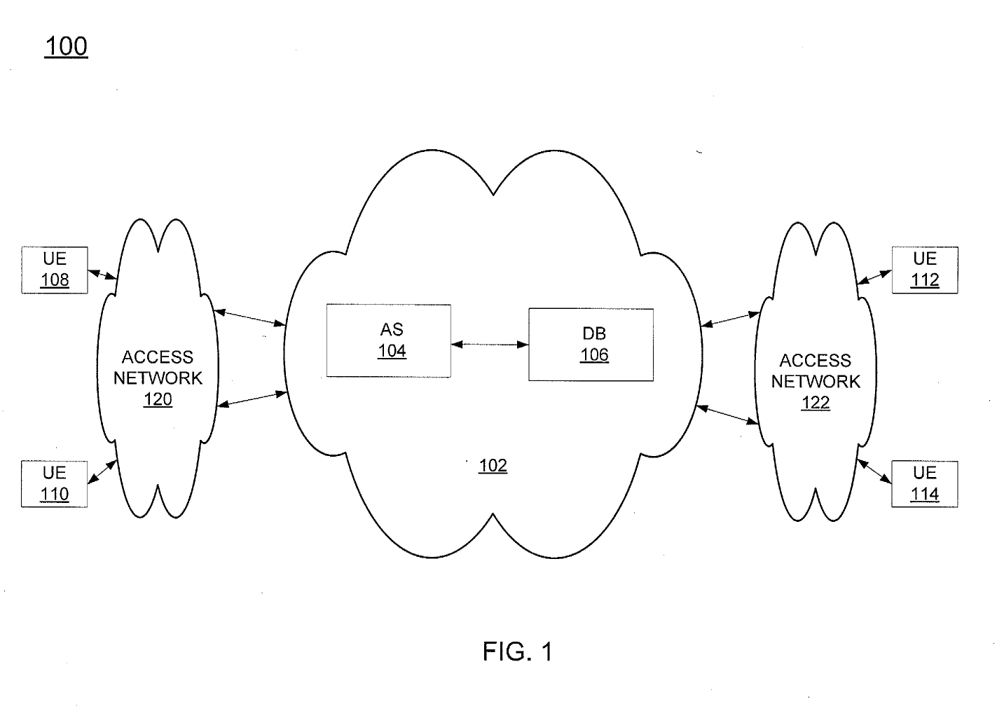

FIG. 1 is a block diagram depicting one example of a communications network 100. The communications network 100 may be any type of communications network, such as for example, a traditional circuit switched network (e.g., a public switched telephone network (PSTN)) or a packet network such as an Internet Protocol (IP) network (e.g., an IP Multimedia Subsystem (IMS) network, an asynchronous transfer mode (ATM) network, a wireless network, a cellular network (e.g., 2G, 3G and the like), a long term evolution (LTE) network, and the like) related to the current disclosure. It should be noted that an IP network is broadly defined as a network that uses Internet Protocol to exchange data packets. Additional exemplary IP networks include Voice over IP (VoIP) networks, Service over IP (SoIP) networks, and the like. It should be noted that the present disclosure is not limited by the underlying network that is used to support the various embodiments of the present disclosure.

In one embodiment, the network 100 may comprise a core network 102. The core network 102 may be in communication with one or more access networks 120 and 122. The access networks 120 and 122 may include a wireless access network (e.g., a WiFi network and the like), a cellular access network, a PSTN access network, a cable access network, a wired access network and the like. In one embodiment, the access networks 120 and 122 may all be different types of access networks, may all be the same type of access network, or some access networks may be the same type of access network and other may be different types of access networks. The core network 102 and the access networks 120 and 122 may be operated by different service providers, the same service provider or a combination thereof.

In one embodiment, the core network 102 may include an application server (AS) 104 and a database (DB) 106. Although only a single AS 104 and a single DB 106 are illustrated, it should be noted that any number of application servers 104 or databases 106 may be deployed.

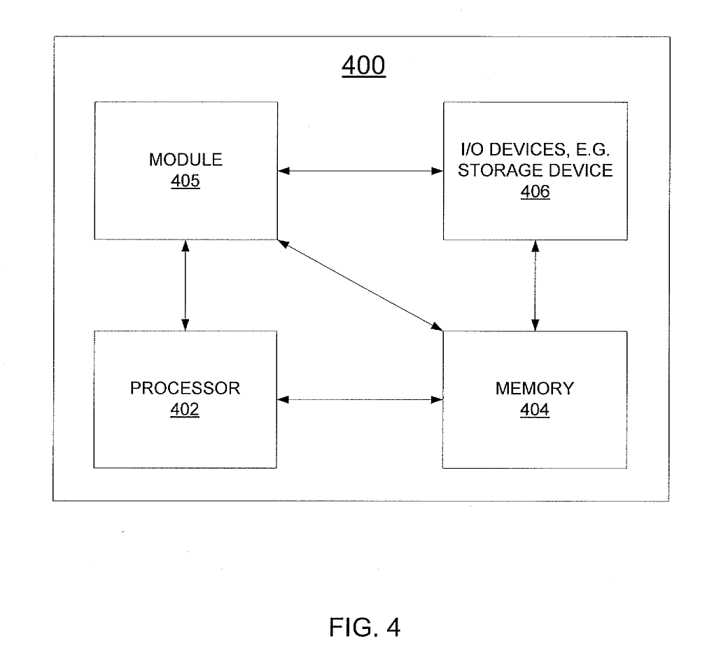

In one embodiment, the AS 104 may comprise a general purpose computer as illustrated in FIG. 4 and discussed below. In one embodiment, the AS 104 may perform the methods and algorithms discussed below related to the searching and/or retrieving of apps.

In one embodiment, the DB 106 may store various information related to apps. For example, the apps may be labeled to be associated with context information that is used for a context search. For example, the context information may include which human senses are needed to operate the app or what type of activities may be performed while using the app. This information may be labeled in any part of the app, for example, the apps meta-data, the manifest files, call graphs, in an app genre description, in a general app description, and the like.

In one embodiment, the DB 106 may store one or more topic models that are used for a topic model search. For example, each app may include in its associated meta-data one or more topics associated with the app. For example, an app named “flight simulator” may include in its meta-data topics such as game, flying, plane, fighter-jet, and the like. As a result, if the user searches for a “flying” app, even though the “flight simulator” app is not an exact match to the word “flying”, the “flight simulator” app may be returned in a search result due to the match of the topic “flying” to the search key word of “flying”. The topic model search is discussed in further details below.

In one embodiment, the DB 106 may also store various indexing schemes used for faster retrieval of the apps. For example, the DB 106 may store indexing schemes such as text indexing, semantic indexing, context indexing, and the like.

In one embodiment, the DB 106 may also store a plurality of apps that may be accessed by users via their endpoint device. In one embodiment, a plurality of databases 106 storing a plurality of apps may be deployed, e.g., a database for storing game apps, a database for storing productivity apps such as word processor apps and spreadsheet apps, a database for storing apps for a particular vendor or for a particular software developer, a database for storing apps to support a particular geographic region, e.g., the east coast of the US or the west coast of the US, and so on. In one embodiment, the databases may be co-located or located remotely from one another throughout the communications network 100. In one embodiment, the plurality of databases may be operated by different vendors or service providers. Although only a single AS 104 and a single DB 106 are illustrated in FIG. 1, it should be noted that any number of application servers or databases may be deployed.

In one embodiment, the access network 120 may be in communication with one or more user endpoint devices (also referred to as “endpoint devices” or “UE”) 108 and 110. In one embodiment, the access network 122 may be in communication with one or more user endpoint devices 112 and 114.

In one embodiment, the user endpoint devices 108, 110, 112 and 114 may be any type of endpoint device such as a desktop computer or a mobile endpoint device such as a cellular telephone, a smart phone, a tablet computer, a laptop computer, a netbook, an ultrabook, a tablet computer, a portable media device (e.g., an iPod® touch or MP3 player), and the like. It should be noted that although only four user endpoint devices are illustrated in FIG. 1, any number of user endpoint devices may be deployed.

It should be noted that the network 100 has been simplified. For example, the network 100 may include other network elements (not shown) such as border elements, routers, switches, policy servers, gateways, firewalls, various application servers, security devices, a content distribution network (CDN) and the like.

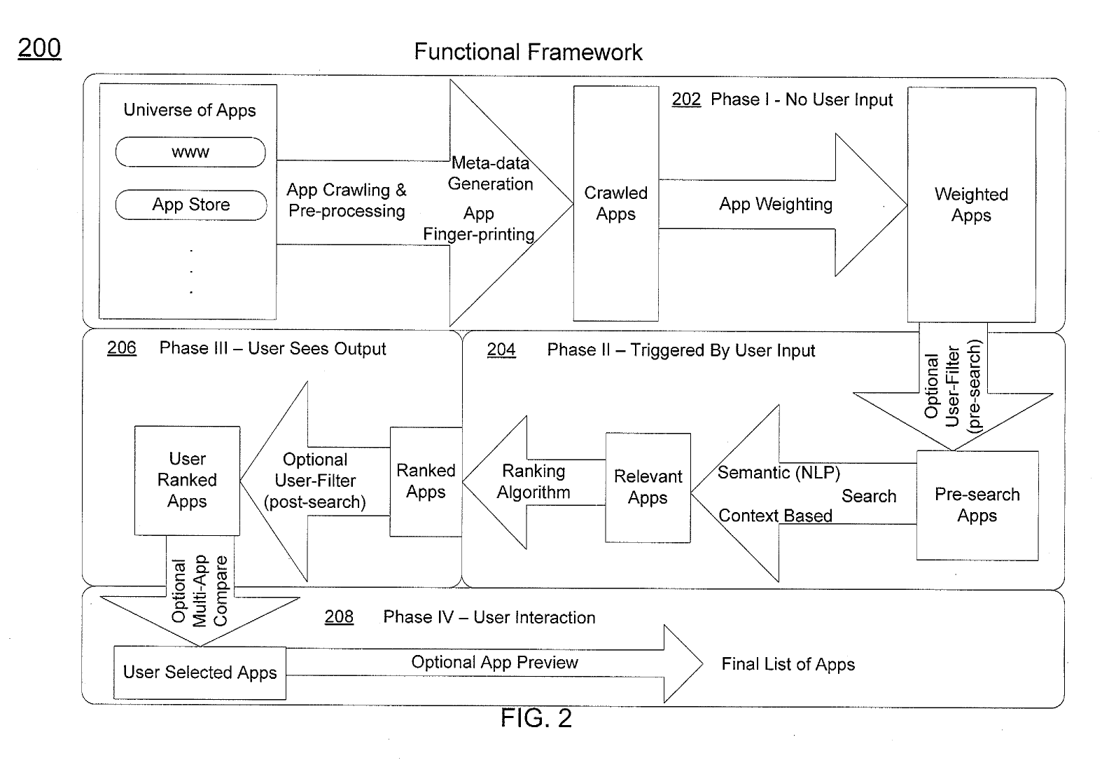

FIG. 2 illustrates an example of a functional framework flow diagram 200 for app searching. In one embodiment, the functional framework flow diagram 200 may be executed for example, in a communication network described in FIG. 1 above.

In one embodiment, the functional framework flow diagram 200 includes four different phases, phase I 202, phase II 204, phase III 206 and phase IV 208. In phase I 202, operations are performed without user input. For example, from a universe of apps, phase I 202 may pre-process each one of the apps to obtain and/or generate meta-data and perform app fingerprinting to generate a “crawled app.” Apps may be located in a variety of online locations, for example, an app store, an online retailer, an app marketplace or individual app developers who provide their apps via the Internet, e.g., websites.

In one embodiment, meta-data may include information such as a type or category of the app, a name of the developer (individual or corporate entity) of the app, key words associated with the app and the like. In one embodiment, the meta-data information may then be further used to crawl the Internet or the World Wide Web to obtain additional information.

In one embodiment, the meta-data and/or other portions of the app may be modified to include context information. The context information may be labels or assigned values with respect to which human senses are required to use the app or what activities may be performed while using the app. This context information may be used when a context search is performed, as discussed in further detail below. Alternately, in one embodiment, information on which senses an app uses may not necessarily be included in the metadata of the app, e.g., they could be in a separate database or inferred in other ways.

In one embodiment, the context information may be included in the meta-data of the app, a manifest file of the app, a call graph of the app, a genre description of the app or a general description of the app. In one embodiment, the information may include labels that identify which senses are required for the app. For example, if the app is a radio app, the meta-data may include information that sound/ear senses (or broadly hearing senses) are required to use the app.

In another embodiment, the information may be more detailed. For example, a chart of human senses may be associated with the app. For example, six human senses may include, sight/eyes (broadly a seeing sense), sound/ears (broadly a hearing sense), touch/hands/feet (broadly a tactile sense), smell/nose (broadly a smelling sense), voice/taste/mouth (broadly a tasting sense) and mood/mind, e.g., the current feeling or mental state of a user such as happy, sad, tired, irritated, calm, stressed and so on (broadly a feeling sense). The chart may include a “+” for any of the senses that are required or a “−” for any of the senses that are not required.

The context information may also include what activities may be performed while using the app. For example, a GPS app may be for use while driving or a recipe app may be used while cooking, and the like. In one embodiment, the context information may also include where the app should be used (e.g., at the office, at home, at school, at a public place, at a stadium, at a restaurant, and the like), when the app should be used (e.g., during daytime, during nighttime, during business hours only, at a particular day of the week, on weekends, and so on), when a particular type of connection is available such as, a Wi-Fi or a 3G connection, and the like) and with whom the app should be used (e.g., alone, with family, with friends, in a large group, with co-workers, by teenagers, by children, and the like).

For example, the app may be loud and the app may have context information that indicates it should be used in a loud public area during the daytime. In another example, the app may be a study aid app and the context information may indicate that the app should be used in a library during the daytime with other students. In yet another example, the app may be an app to aid sleeping and the context information may indicate that the app should be used at home at nighttime. In other words, the context information may broadly include what, where, when and/or with whom the app should be used, as well as which sense are required for the app. It should be noted that the above examples are only a few examples and should not be considered limiting of the scope of the present disclosure. Again alternatively, context information may come from different sources and it does not need to be included in the app metadata.

At phase I 202, the method may optionally apply a weight to each application to generate a “weighted app.” For example, the weight can be applied in accordance with various parameters, e.g., a reputation of the app developer, a cost of app, the quality of the technical support provided by the developer, a size of the app (e.g., memory size requirement), ease of use of the app in general, ease of use based on the user interface, effectiveness of the app for its intended purpose, and so on. For example, a reputation of a developer for developing particular types of apps may optionally also be obtained, e.g., from a public online forum, from a social network website, from an independent evaluator, and so on. The reputation information implemented via weights may then be used to calculate an initial ranking for each one of the apps, e.g., a weight of greater than 1 can be applied to a developer with a good reputation, whereas a weight of less than 1 can be applied to a developer with a poor reputation. It should be noted that the weights (e.g., with a range of 1-10, with a range between 0-1, and so on) can be changed based on the requirements of a particular implementation.

An optional user based filtering step can be applied once the apps are weighted and an initial ranking for each of the apps is computed. For example, each user may have a predefined set of parameters that are to be applied to all of the apps, e.g., excluding all apps of a particular size due to hardware limitation, excluding all apps based on a cost of the apps, excluding all apps from a particular developer and so on. It should be noted that this step is only applied if the user has a predefined set of filter criteria to be applied to generate “pre-search apps”.

Alternatively, once the apps are weighted and an initial ranking for each of the apps is computed, phase II 204 is triggered by user input. For example, during phase II 204 a user may input a search query for a particular app. In one embodiment, the search may be based upon a natural language processing (NLP) or semantic query. For example, the search may simply be a search based upon matches of keywords provided by the user in the search query that is provided in a natural language format.

In one embodiment, the search may be based upon a context based query. For example, the search may be performed based upon context information associated with a user and context information associated with an app. In one embodiment, context information associated with the user may include which human senses are being used or are free. The context information associated with the user may also include what (an activity type parameter, e.g., a type of activity the user is participating in such as a particular type of sports activity, a particular work related activity, a particular school related activity and so on), where (a location parameter, e.g., a location of an activity, such as indoor, outdoor, at a particular location, at home, at work, and the like), when (a time parameter, e.g., a time of day, in the morning, in the afternoon, a day of the week, etc.) and with whom (a person parameter, e.g., a single user, a group of users, friends, family, an age of the user and the like) the user is performing an activity.

In one embodiment, the context information may be provided by a user. For example, via a web interface, the user may enter a search based upon context information or provide information as to what activity he or she is performing, who is with the user, and the like. Some examples of search phrases may include “apps to use while I'm driving,” “apps to use while I'm cooking,” “gaming apps for a large group of people,” and the like. In addition, the user may enter information on what senses are available. For example, the user may provide information that the user's hands are free or that the user may listen or interact verbally with an app, and the like. Alternatively, context information on what senses are used by an activity may also be inferred by the search algorithm through some definition of the activity and so on (e.g., from the activity “driving” and its definition, synonyms, etc., the system may be able to infer that the activity uses hands, eyes and feet).

In another embodiment, the context information may be automatically provided via one or more sensors on an endpoint device of the user. For example, the sensors may include a microphone, a video camera, a gyroscope, an accelerometer, a thermometer, a global positioning satellite (GPS) sensor, and the like. As a result, the endpoint may provide context information such as the user is moving based upon detection of movement by the accelerometer, who is in the room with the user based upon images captured by the video camera, where the user is based upon images captured by the video camera and location information from the GPS sensor, and the like.

In one embodiment, after the context information is processed from the search request, the context information of the user may be compared against the context information labeled in the apps. As discussed above, in phase I 202 the apps may be modified to include context information. Using the context information of the user from the search request and the context information labeled in the apps, the searching algorithm may provide in the search results apps that have matching context information or do not require the use of any of the senses that are being used. In other words, if the user's sense of sight/eyes is being used, then no apps that require the sense of sight/eyes would be returned in the search results.

To illustrate, in one example of a context search, the user may be cooking. The user may use a voice recognition method (e.g., software application) to verbally submit a search request for apps while cooking. In one embodiment, the search request may be processed to determine that cooking requires the use of the user's senses such as touch/hands and sight/eyes and that the senses of smell/nose, sound/ears, voice/mouth and mood/mind are available.

In addition, the microphone and voice recognition software in the user's endpoint device may recognize that the user is Bob Smith. In one embodiment, Bob Smith may have a user profile pre-established and stored in the endpoint device or the DB 106 of the network for various user preferences of apps, music, and the like. In another embodiment, the user preferences may be tracked over a period of time based upon Bob Smith's activity. For example, Bob Smith may have a preference for music apps that include rock music by certain artists.

As a result, the search request may be processed such that the search results provide apps that can be used while cooking such as a radio app, an audio book app, a voice recording app and the like. In one embodiment, the apps may be prioritized in the results based upon Bob Smith's preferences for music apps that include rock music by certain artists. For example, the top search result may be an Internet radio app that plays rock music by Bob Smith's favorite artists.

In other words, the search results were based upon the context information that was received. The context information in the above example included the senses that were available based upon the activity, e.g., cooking. In addition, sensors on the user's endpoint device were able to detect who was making the request, e.g., Bob Smith, based upon the voice recognition software and microphone in the endpoint device. Thus, based upon the context information and the predefined user preferences, the search results may provide a list of apps specifically for Bob Smith while he is cooking.

Other examples of context searching may be evident based upon the above example. For example, if a user searches for a “cooking app” and the endpoint detects that Bob Smith is in the kitchen via a video camera, the search result may include cooking apps that include Bob Smith's favorite types of foods or sort recipes as per Bob Smith's preference. The above examples are only provided as a few illustrative examples and should not be considered limiting.

In one embodiment, a topic model search algorithm may be applied to the searching, e.g., the NLP search or the context search. For example, using a simple key word search, if a user looks for an app based upon a key word “flying”, apps that are entitled “flight simulator,” “space shooter” and “flight times” may not be returned because they do not exactly match the key word “flying”.

However, using a topic model search algorithm, the apps may have various topics included in their associated meta-data. For example, the meta-data for the “flight simulator” app may include topics such as game, flying, plane, fighter-jet, and the like. The meta-data for the “space shooter” app may include topics such as game, spaceship, pilot and the like. The meta-data for the “flight times” app may include topics such as track, flights, airplane, airport and the like. As a result, if the user searches for an app with the key word “flying”, the “flight simulator” app may be returned in the search results based on a match of the topics.

Similarly, the topic model search algorithm may be applied to the context based search. For example, if the user searches for an app using a search phrase “flying games while listen to the radio”, the context search may look for apps that match context information and include the word flying. However, using the topic model search algorithm the search may also include the “flight simulator” app even though there is not an exact match to the key word “flying” based upon the match in the topics.

The topic model search algorithm may use any type of algorithm. In one embodiment, a latent dirichlet allocation algorithm may be used.

In one embodiment, the app included in the search result may be retrieved from a database that uses an index to store a plurality of apps. For example, rather than having the apps stored in a random fashion, the apps may be stored in a database using indexing. Indexing schemes such as, for example, a text index, a semantic index, a context index, and the like, may be deployed.

In one embodiment, the text index may associate a term with a list of app identifications (IDs). In one embodiment, the semantic index may use B-trees on multidimensional data. In addition, each node may have minimum bounding rectangles and pointers to children nodes. In one embodiment, the context index may use binary string keys. For example, using six human senses would require 2⁶ or 64 binary string keys. The string keys may be indexed as a table and associated with a list of app IDs. As result, using indexing to store the plurality of apps provides a more efficient search result and retrieval of the apps.

In phase II 204, a ranking algorithm may also be applied to the apps. In one embodiment, the “final” ranking may be calculated based upon the initial ranking, a context based ranking, an NLP ranking and/or a user feedback ranking. For example, weight values of each of the rankings may be added together to compute a total weight value, which may then be compared to the total weight values of the other apps.

At phase III 206, the results of the final ranking are presented to the user. During phase III 206, the user may apply one or more optional post search filters to the ranked apps, e.g., various filtering criteria such as cost, hardware requirement, popularity of the app, other users' feedback, and so on. The post search filters may then be applied to the relevant ranked apps to generate a final set of apps that will be presented to the user.

At phase IV 208, the user may interact with the apps. For example, the user may select one of the apps and either preview the app or download the app for installation and execution on the user's endpoint device.

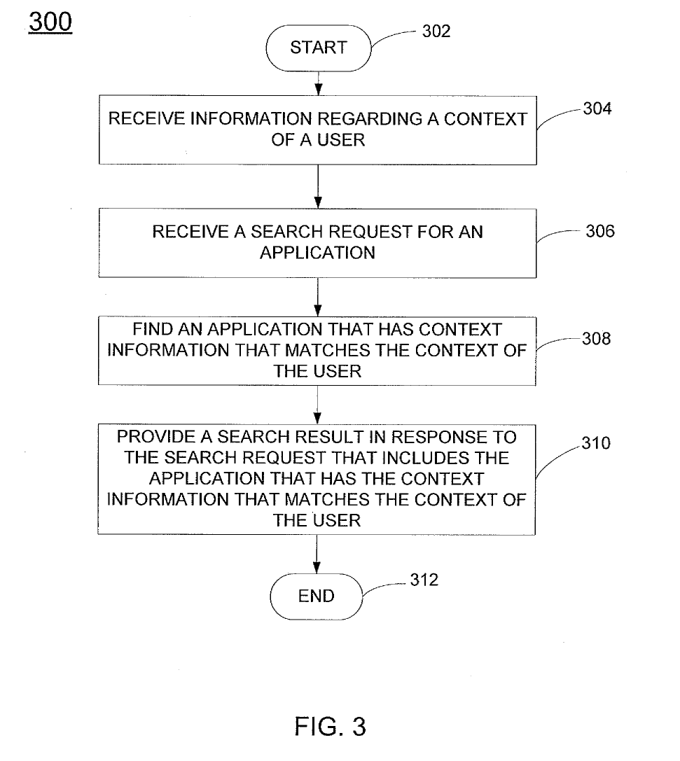

FIG. 3 illustrates a flowchart of a method 300 for searching for and retrieving an app. In one embodiment, the method 300 may be performed by the AS 104 or a general purpose computing device as illustrated in FIG. 4 and discussed below.

The method 300 begins at step 302. At step 304, the method 300 receives information regarding a context of a user. In one embodiment, the context information may be provided by a user. For example, via a web interface, the user may enter a search based upon context information. Some examples of search phrases may include “apps to use while I'm driving,” “apps to use while I'm cooking,” “gaming apps for a large group of people,” and the like. In addition, the user may enter information on what senses are available. For example, the user may provide information that the user's hands are free or that the user may listen or interact verbally with an app, and the like. Again alternatively, what senses are free can also be inferred from the activity automatically without the user having to specify it.

In another embodiment, the context information may be automatically provided via one or more sensors located on an endpoint device of the user. For example, the sensors may include a microphone, a video camera, a gyroscope, an accelerometer, a thermometer, a global positioning satellite (GPS) sensor and the like. As a result, the endpoint device may provide context information such as the user is currently moving based upon detection of movement by the accelerometer, who is in the room with the user based upon images captured by the video camera, where the user is based upon images captured by the video camera and location information from the GPS sensor, and the like.

At step 306, the method 300 receives a search request for an app. For example, the user may simply enter a key word search or provide a search phrase for an app that the user is looking for.

In one embodiment, the context information may be sent in conjunction with the search request. For example, if the context information is automatically gathered by a sensor on the endpoint device, the information may be sent with the search request. In another embodiment, the context information may be part of the search request. For example, if the user enters a search request for “apps to use while I'm driving,” the search request can be processed to determine that the user is driving. From this information it can be determined that the user's sight/eye and touch/hand senses may be occupied.

At step 308, the method 300 finds one or more apps that have context information that matches the context of the user. As discussed above, the apps may be modified such that they are labeled with context information. In one embodiment, the context information may include labels that identify which senses are required for the app, a chart with all six human senses that include a “+” for any of the senses that are required or a “−” for any of the sense that are not required, what activities may be performed while using the app, and the like.

The search request for the app may be processed to obtain the context information (broadly a context or a context parameter) of the user. The context information may be matched against one or more apps that include matching context information (broadly a context or a context parameter associated with the apps). For example, it may be required that at least one sense required for the app matches an available sense of the user, that the app does not require any of the senses that are being used by the user, the app matches an activity that the app should be used for that was requested by the user, and the like. In one embodiment, it may be required that all of the context information of the app must match exactly with the context information of the user.

At step 310, the method 300 provides a search result in response to the search request that includes one or more apps that are compatible within the context of the user. In one embodiment, the search may also apply a topic model search algorithm, as described above. In one embodiment, the topic model search algorithm may be a dirichlet allocation algorithm.

In addition, for faster retrieval of the apps that are found for the search result, the apps may be stored using an indexing method. For example, rather than having the apps stored in a random fashion, the apps may be stored in a database using indexing. Indexing schemes such as, for example, a text index, a semantic index, a context index and the like may be deployed. At step 312, the method 300 ends.

As a result, the user may search for apps that are relevant to the user's context, e.g., what activity the user is performing, when the user is performing the activity, with whom the user is performing the activity and what senses are engaged or free while the user is performing the activity. As a result, the context search approach is able to only provide those apps that the user may utilize while performing a particular activity or that is specific to the user or the user's surroundings.

It should be noted that although not explicitly specified, one or more steps of the method 300 described above may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in FIG. 3 that recite a determining operation, or involve a decision, do not necessarily require that both branches of the determining operation be practiced. In other words, one of the branches of the determining operation can be deemed as an optional step. Furthermore, operations, steps or blocks of the above described methods can be combined, separated, and/or performed in a different order from that described above, without departing from the example embodiments of the present disclosure.

FIG. 4 depicts a high-level block diagram of a general-purpose computer suitable for use in performing the functions described herein. As depicted in FIG. 4, the system 400 comprises a hardware processor element 402 (e.g., a CPU), a memory 404, e.g., random access memory (RAM) and/or read only memory (ROM), a module 405 for searching for and retrieving an app, and various input/output devices 406, e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

It should be noted that the present disclosure can be implemented in software and/or in a combination of software and hardware, e.g., using application specific integrated circuits (ASIC), a general purpose computer or any other hardware equivalents, e.g., computer readable instructions pertaining to the methods) discussed above can be used to configure a hardware processor to perform the steps of the above disclosed method. In one embodiment, the present module or process 405 for searching for and retrieving an app can be implemented as computer-executable instructions (e.g., a software program comprising computer-executable instructions) and loaded into memory 404 and executed by hardware processor 402 to implement the functions as discussed above. As such, the present method 405 for searching for and retrieving an app as discussed above in method 300 (including associated data structures) of the present disclosure can be stored on a non-transitory (e.g., tangible or physical) computer readable storage medium, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for searching for an application, comprising:
receiving information regarding a context of a user;
receiving a search request for the application;
finding the application that has context information that matches the context of the user; and
providing a search result in response to the search request that includes the application that has the context information that matches the context of the user.

2. The method of claim 1, wherein the information regarding the context of the user is provided by the user.

3. The method of claim 1, wherein the information regarding the context of the user is provided automatically via a sensor on an endpoint device of the user.

4. The method of claim 1, wherein the information regarding the context of the user is inferred from an activity to be performed by the user.

5. The method of claim 1, wherein the context comprises an activity that the user is performing.

6. The method of claim 1, wherein the context comprises a sense that the user is using.

7. The method of claim 6, wherein the application included in the search result does not require a use of the sense that the user is using.

8. The method of claim 1, wherein the search result is provided by applying a topic search model.

9. The method of claim 8, wherein a latent dirichlet allocation algorithm is used to apply the topic search model.

10. The method of claim 1, wherein the application included in the search result is retrieved from a database that uses an index to store a plurality of applications.

11. A non-transitory computer-readable medium having stored thereon a plurality of instructions, the plurality of instructions including instructions which, when executed by a processor, cause the processor to perform operations for searching for and retrieving an application, the operations comprising:
receiving information regarding a context of a user;
receiving a search request for the application;
finding the application that has context information that matches the context of the user; and
providing a search result in response to the search request that includes the application that has the context information that matches the context of the user.

12. The non-transitory computer-readable medium of claim 11, wherein the information regarding the context of the user is provided by the user.

13. The non-transitory computer-readable medium of claim 11, wherein the information regarding the context of the user is provided automatically via a sensor on an endpoint device of the user.

14. The non-transitory computer-readable medium of claim 11, wherein the information regarding the context of the user is inferred from an activity to be performed by the user.

15. The non-transitory computer-readable medium of claim 11, wherein the context comprises an activity that the user is performing.

16. The non-transitory computer-readable medium of claim 11, wherein the context comprises a sense that the user is using.

17. The non-transitory computer-readable medium of claim 16, wherein the application included in the search result does not require a use of the sense that the user is using.

18. The non-transitory computer-readable medium of claim 11, wherein the search result is provided by applying a topic search model.

19. The non-transitory computer-readable medium of claim 18, wherein a latent dirichlet allocation algorithm is used to apply the topic search model.

20. An apparatus for searching for an application, comprising:
a processor; and
a computer-readable medium in communication with the processor, wherein the computer-readable medium has stored thereon a plurality of instructions, the plurality of instructions including instructions which, when executed by the processor, cause the processor to perform operations, the operations comprising:
receiving information regarding a context of a user;
receiving a search request for an application;
finding the application that has context information that matches the context of the user; and
providing a search result in response to the search request that includes the application that has the context information that matches the context of the user.
